(19) United States
(12) Patent Application Publication
(10) Pub. No.: US 2021/0365856 A1
(43) Pub. Date: Nov. 25, 2021

(54) Machine Learning Platform for Dynamic Resource Management

(71) Applicant: Bank of America Corporation, Charlotte, NC (US)

(72) Inventors: Maharaj Mukherjee, Poughkeepsie, NY (US); Utkarsh Raj, Charlotte, NC (US); Jigar Shah, Franklin Township, NJ (US)

(21) Appl. No.: 16/879,918

(22) Filed: May 21, 2020

(51) Int. Cl. G06Q 10/06; G06N 20/00; G06N 5/04; G06F 9/50; G06Q 10/10

(52) U.S. Cl. CPC G06Q 10/06312; G06N 20/00; G06N 5/04; G06F 9/5083; G06Q 10/06313; G06Q 10/067; G06Q 10/103; G06Q 10/105; G06Q 10/06398; G06Q 10/06393; G06Q 10/06395; G06Q 10/06316

(57) ABSTRACT

Aspects of the disclosure relate to using machine learning techniques for dynamic resource management. A computing platform may collect historical productivity data and use it to train a resource management model. The computing platform may identify specifications and a resource allocation combination for the first project using the resource management model. The computing platform may send task assignment commands to enterprise applications running on user devices corresponding to the resource allocation combination directing them to display a task list based on the specifications and the resource allocation combination. The computing platform may dynamically monitor a project management application. In response to detecting a resource modification flag, the computing platform may apply the resource management model to dynamically identify resource reassignments for the first project. The computing platform may send task reassignment commands to the user devices directing them to display an updated task list based on the resource reassignments.

### BACKGROUND

Aspects of the disclosure relate to resource management systems for enterprise organizations. In particular, one or more aspects of the disclosure relate to computing platforms that implement machine learning methods in performing dynamic resource management and allocation.

In some cases, an enterprise organization may measure resource productivity using quantitative methods, comparisons to industry standards, co-worker feedback surveys, or the like. In some instances, however, resources may be allocated to projects without an enterprise-wide productivity analysis that matches resources to projects based on project specifications and historical productivity data corresponding to the resources. Accordingly, such methods may result in high project costs, delays, error prone results, or the like. Furthermore, some projects may occur in phases (e.g., agile development), and each phase may reveal operational inefficiencies. Enterprise organizations may set initial project teams, however, and may fail to implement adaptive resource management techniques in adjusting resource allocations, which may allow these operational inefficiencies to persist throughout all remaining project phases. Additionally or alternatively, resources may be unable to complete certain tasks due to illness, vacation, or the like, and enterprise organizations may be unable to reassign these tasks in an optimal fashion. As a result, it may be difficult for enterprise organizations to optimally deploy resources based on productivity data, which may result in inefficient enterprise operations.

### SUMMARY

Aspects of the disclosure provide effective, efficient, scalable, and convenient technical solutions that address and overcome the technical problems associated with resource allocation. For example, some aspects of the disclosure provide techniques that may enable computing devices to generate a resource management model based on historical productivity data, which may be used to identify optimal resource allocations, dynamically reassign tasks, and optimize project reassignments once projects are complete. In doing so, various technical advantages may be realized. For example, one technical advantage of applying machine learning to historical productivity data is that optimal resource combinations may be identified for projects without manually combing through resumes or feedback forms. Another technical advantage is that resource combinations may be optimally adjusted in the event that a previously selected resource becomes temporarily or permanently unavailable. Yet another technical advantage is that once projects are completed, resources may be automatically reassigned in an optimal manner based on their historical productivity data. In doing so, resources may be reassigned in a quicker manner than if manual staffing were to be used, and as described above, the reassignments may be optimized using historical productivity data. Accordingly, these advantages may result in reduced costs, delays, and errors across various tasks, projects, and enterprise organizations.

In accordance with one or more embodiments of the disclosure, a computing platform comprising at least one processor, a communication interface, and memory storing computer-readable instructions may collect historical productivity data. The computing platform may train a resource management model using the historical productivity data. The computing platform may identify project specifications for a first project. Using the resource management model, the computing platform may identify a resource allocation combination for the first project. The computing platform may send one or more task assignment commands to one or more enterprise applications running on one or more user devices corresponding to the resource allocation combination, the one or more task assignment commands directing each of the one or more enterprise applications running on the one or more user devices to display a task list based on the project specifications and the resource allocation combination, which may cause each of the one or more enterprise applications running on the one or more user devices to display the task list. After sending the one or more task assignment commands to the one or more enterprise applications running on the one or more user devices corresponding to the resource allocation combination, the computing platform may dynamically monitor a project management application. The computing platform may detect a resource modification flag based on dynamically monitoring the project management application. In response to detecting the resource modification flag, the computing platform may apply the resource management model to dynamically identify resource reassignments for the first project. The computing platform may send one or more task reassignment commands to the one or more enterprise applications running on the one or more user devices corresponding to the resource allocation combination, the one or more task reassignment commands directing each of the one or more enterprise applications running the one or more user devices to display an updated task list based on the identified resource reassignments, which may cause each of the one or more enterprise applications running on the one or more user devices to display the updated task list.

In one or more instances, the computing platform may detect a project completion flag based on dynamically monitoring the project management application. In response to detecting the project completion flag, the computing platform may apply the resource management model to dynamically identify alternate projects to which resources comprising the resource allocation combination may be reassigned. The computing platform may send one or more project reassignment commands to the one or more enterprise applications running on the one or more user devices corresponding to the resource allocation combination, the one or more project reassignment commands directing each of the one or more enterprise applications running on the one or more user devices to display a second updated task list based on the identified alternate projects, which may cause each of the one or more enterprise applications running on the one or more user devices to display the second updated task list.

In one or more instances, the historical productivity data may be productivity data for individual resources based on: their performance with regard to other specific resources, their performance on teams with specific compositions, or their performance within a job function, and the historical productivity data may be stored using resource profiles. In one or more instances, each resource profile may include the job function and a rank within the job function.

In one or more instances, the computing platform may compute, for each of the resource profiles, the productivity data based on the performance within a job function by comparing actual performance metrics stored in the resource profiles to benchmark performance metrics corresponding to the job function and the rank within the job function. In one or more instances, the benchmark performance metrics may be specific to the job function and the rank within the job function.

In one or more instances, the benchmark performance metrics may be one or more of: a number of lines of code written, a number of tests run, a number of lines of text written, or a number of flowcharts drawn. In one or more instances, the historical productivity data may correspond to internal resources and external resources.

In one or more instances, in response to detecting the project completion flag, the computing platform may send one or more feedback commands to the one or more enterprise applications running on the one or more user devices corresponding to the resource allocation combination. The computing platform may receive, from the one or more enterprise applications running on the one or more user devices corresponding to the resource allocation combination, feedback corresponding to the resource allocation combination. Using the feedback, the computing platform may update the resource management model.

In one or more instances, the specific compositions may include specific numbers of resources on the teams corresponding to a particular job function and a particular rank within the job function.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for implementing machine learning techniques for dynamic resource management in accordance with one or more example embodiments;

FIGS. 2A-2G depict an illustrative event sequence for implementing machine learning techniques for dynamic resource management in accordance with one or more example embodiments;

FIGS. 3-5 depict illustrative graphical user interfaces for implementing machine learning techniques for dynamic resource management in accordance with one or more example embodiments; and

FIG. 6 depicts an illustrative method for implementing machine learning techniques for dynamic occupancy forecasting in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances, other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction to the concepts described further herein, one or more aspects of the disclosure provide systems and methods to efficiently and effectively manage resources using machine learning. For example, productivity of a team may be used as a metric to measure success. More specifically, progress in an agile methodology (e.g., for software development, or the like), may occur in small iterations. In these instances, it may be important to measure productivity for each iteration, and to take corrective action accordingly to improve overall productivity.

In some instances, employers may measure employee productivity using a quantitative method. For example, using a quantitative method, productivity may be measured based on a number of parts, products, deliverables, or the like that an employee produces within a particular period of time (e.g., such as an iteration or sprint of an agile software development process). To do so, in some instances, productivity may be calculated using productivity software, a spreadsheet, or the like, that may maintain employee production numbers (e.g., over the particular period of time), and these numbers may be averaged to reveal productivity gains and/or losses over time. In some instances, employee output may be measured by volume and/or quantity of products created, financial value of a product or service, or the like.

As a particular example, for people working in software, information technology, or the like, productivity may be measured based on a particular role within the industry. For example, a number of designs created, proofs of concept executed, or the like may be used to measure productivity of a software architect. In contrast, a number of lines of code that are checked into production, a number of bugs fixed, or the like may be used to measure productivity of a programmer. With regard to code testers, their productivity may be measured based on a number of test cases run and/or documented over a period of time, or the like.

In some instances, for a group of employees (e.g., an agile group) that includes different skill sets, productivity may be measured based on each different skill set and a summation (e.g., a Euclidean summation, Manhattan summation, or the like) may be computed.

In some instances, a 360 degree feedback method may be applied to measure productivity (e.g., using feedback and comments of co-workers). This may be used in instances where employees frequently interact with each other, but might not be accurate in instances where employees do not frequently interact. Similarly, in this method, it may be important for employee productivity to be evaluated by everyone that the employee works or otherwise interacts with on a daily basis (subordinates, supervisors, or the like). To provide accurate feedback, evaluators must know and understand an overall job role/function, daily work duties, professional credentials, communication skills, or the like for the employee. As a result, this feedback method may be most effective in small departments or organizations where employees all know and interact with each other.

In some instances, all employees (from managers to information technology workers to receptionists) may give feedback on employee levels of productivity in terms of how well an employee has fulfilled his or her duties and contributed to overall company productivity. In evaluating a particular team, however, only members of a particular team may evaluate him or her (e.g., in terms of their contributions to team productivity).

One or more of the systems and methods described herein provide an artificial intelligence based machine learning method that identifies a team of employees (e.g., within an agile development environment, or the like) that will operate as a unit with enhanced productivity.

A linear regression model for machine learning is used for optimizing individual or group productivity (e.g., within an agile development environment). This model may also be used to identify, in real time, how to modify or otherwise update an existing team when certain team members may be unable to participate with the team. For example, in some instances, unforeseen circumstances such as sickness, family emergencies, or the like may arise. Additionally, some circumstances may be predicted in advance such as weather or traffic conditions that may impact or otherwise limit availability of team members.

In some instances, historic data from organizations may indicate employee participation in various team scenarios, participation in various roles, demonstration of various skills, or the like, and how such historic data impacted productivity (e.g., based on employee records). In some instances, such information may be available from organizations, such as through human resources data that provides a location of each employee in an office space, along with their performance and/or productivity records.

In some instances, appropriate error and/or bias may be chosen in the machine learning model so that the data is neither over fitted nor under fitted. The model may be iteratively refined for an appropriate level of precision, recall, and/or other metrics of a machine learning model. In some instances, the model may be further improved by combining several predictors by polling and computing an average of all the predictions for model stability. In some instances, the model may incorporate randomization techniques such as boosting, bagging, random forest, or the like. In some instances, the model may be further improved by incorporating more recent data as and when it becomes available.

In some instances, variants in the model may be employee skills, availability in terms of time zones and vacation plans, traffic, weather, or the like, and the cost function to be optimized may be productivity. In these instances, a machine learning regression model may use project specifications such as required skill, timeline, or the like to generate a list of candidate team members who may be able to work on a particular project. Then, machine learning models may be used to decide who will work when, and how to assign work based on availability (taking into account time zones, vacation plans, or the like). In some instances, work may be assigned in real time if a team is created from around the globe from various time zones. In these instances, work may be performed twenty-four hours a day, seven days a week. As described above, in some instances, team and/or work assignments may be updated in real time if a member becomes unavailable for unforeseen or other circumstances.

In doing so, one or more of the systems and methods described herein may provide techniques for using machine learning and artificial intelligence based methods to organize employees (e.g., for agile teams) to increase and optimize the productivity metric. This method uses historic data to create a machine learning model and uses the model to create an arrangement that optimizes individual or group productivity based on available skills in real time.

Accordingly, by performing one or more of the methods described above, one or more of the systems described herein may dynamically measure and optimize productivity at an individual, team, and/or enterprise level. To do so, performance data may be analyzed at a role and/or task level in short intervals so that a machine learning model used to optimize productivity may be further refined. The result of such dynamic analysis and management of the machine learning model is a model that may be used to initially define teams to maximize productivity, and may make changes to the teams and/or individual task lists to avoid (or minimize) the resulting impact on productivity. This may conserve resources in project management, and may further conserve processing resources (e.g., that may otherwise result due to inefficient programming, testing, or the like). Furthermore, by optimizing and refining teams for agile development upfront and after each iteration, a number of development iterations may be minimized, which may further conserve both human and processing resources.

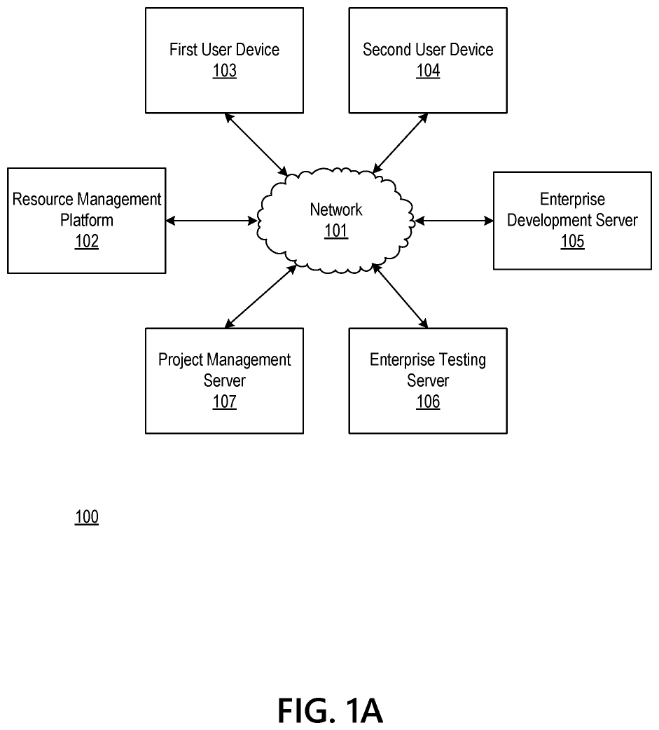

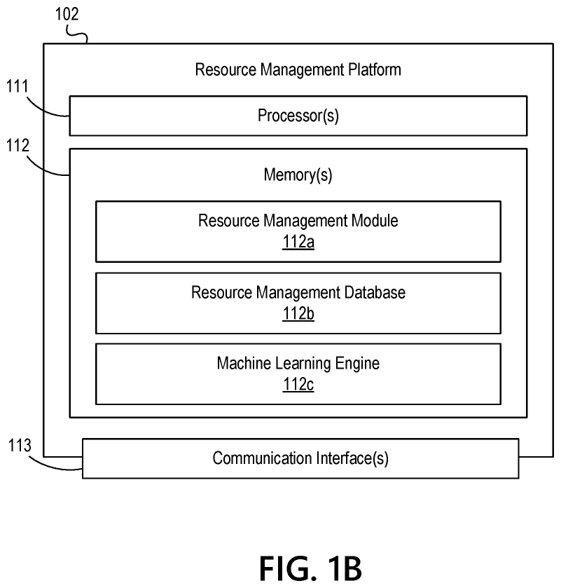

FIGS. 1A-1B depict an illustrative computing environment that implements machine learning techniques for dynamic resource management in accordance with one or more example embodiments. Referring to FIG. 1A, computing environment 100 may include one or more computer systems. For example, computing environment 100 may include a resource management platform 102, first user device 103 (which may host one or more first enterprise applications), second user device 104 (which may host one or more second enterprise applications), enterprise development server 105, enterprise testing server 106, and project management server 107.

As described further below, resource management platform 102 may be a computer system that includes one or more computing devices (e.g., servers, server blades, or the like) and/or other computer components (e.g., processors, memories, communication interfaces) that may be used to implement machine learning models to identify, optimize, and dynamically modify enterprise resources (e.g., employees, contractors, or the like). In some instances, the resource management platform 102 may be configured to maintain a machine learning model that may include user profiles containing various productivity data such as employment information, actual productivity metrics, baseline productivity metrics, or the like. In some instances, resource management platform 102 may be configured to dynamically monitor project management server 107 to identify flags indicating performance disruptions and/or project completion, and may apply the machine learning model to update teams accordingly based on the flags (e.g., to maximize productivity). In some instances, resource management platform 102 may be configured to dynamically adjust or otherwise update the machine learning model based on feedback and/or additional information.

First user device 103 may be a mobile device, tablet, smartphone, desktop computer, laptop computer, or the like, that may be used by an individual to perform tasks for an enterprise organization. In some instances, the first user device 103 may be used by an employee or contractor of the enterprise organization to perform one or more tasks related to agile software development (e.g., architecture design, programming, testing, project management, or the like). In some instances, the first user device 103 may be configured to display one or more tasks lists, and may be configured to update the task lists (e.g., in response to one or more commands from the resource management platform 102). For illustrative purposes, first user device 103 is described throughout the following event sequence with regard to performing one or more software development tasks. In some instances, first user device 103 may be configured to host one or more enterprise applications or otherwise allow the enterprise organizations to run on the first user device 103.

Second user device 104 may be a mobile device, tablet, smartphone, desktop computer, laptop computer, or the like, that may be used by an individual to perform tasks for an enterprise organization. In some instances, the second user device 104 may be used by an employee or contractor of the enterprise organization to perform one or more tasks related to agile software development (e.g., architecture design, programming, testing, project management, or the like). In some instances, the second enterprise user device 104 may be configured to display one or more tasks lists, and may be configured to update the task lists (e.g., in response to one or more commands from the resource management platform 102). In some instances, second user device 104 may host second enterprise applications that may be used to perform similar or different tasks than those performed using first enterprise applications running on first user device 103. For illustrative purposes, second user device 104 is described throughout the following event sequence with regard to performing one or more software testing tasks (e.g., using one or more enterprise applications).

Enterprise development server 105 may be a server, server blade, or the like configured to store data associated with enterprise activities (e.g., software development, or the like). In some instances, enterprise development server 105 may be configured to store performance data for one or more employees related to the data stored at the enterprise development server 105 (e.g., number of lines of code checked into production, number of bugs fixed, or the like), and may, in some instances, store correlations between the data and one or more employees on which the data is based. For example, enterprise development server 105 may be used to store data related to one or more development related activities performed at the first enterprise applications running on at least one user device (e.g., first user device 103).

Enterprise testing server 106 may be a server, server blade, or the like configured to store data associated with enterprise activities (e.g., software testing, or the like). In some instances, enterprise testing server 106 may be configured to store performance data for one or more employees related to the data stored at the enterprise testing server 106 (e.g., number of test cases run and documented over a period of time, or the like), and may, in some instances, store correlations between the data and one or more employees on which the data is based. For example, enterprise testing server 106 may be used to store data related to one or more test related activities performed at the second enterprise applications running on at least one user device (e.g., second user device 104).

Project management server 107 may be a server, server blade, or the like configured to store data associated with enterprise activities (e.g., project management, or the like). In some instances, enterprise development server 105 may be configured to store performance data for one or more employees and/or progress data for one or more enterprise projects. In some instances, the project management server 107 may be configured to set one or more flags related to performance disruptions (e.g., employee absences, or the like) and/or project completion. In some instances, project management server 107 may be configured to monitor projects across the enterprise organization, so as to efficiently optimize reallocation of resources between projects.

Although FIG. 1A depicts an enterprise development server 105, enterprise testing server 106, and project management server 107, this is for illustrative purposes only, and servers related to other enterprise efforts (e.g., system architecture design, or the like) may be included in the network 101.

Computing environment 100 also may include one or more networks, which may interconnect resource management platform 102, first user device 103, second user device 104, enterprise development server 105, enterprise testing server 106, project management server 107, or the like. For example, computing environment 100 may include a network 101 (which may interconnect, e.g., resource management platform 102, first user device 103, second user device 104, enterprise development server 105, enterprise testing server 106, project management server 107, or the like).

In one or more arrangements, resource management platform 102, first user device 103, second user device 104, enterprise development server 105, enterprise testing server 106, and/or project management server 107 may be any type of computing device capable of sending and/or receiving requests and processing the requests accordingly. For example, resource management platform 102, first user device 103, second user device 104, enterprise development server 105, enterprise testing server 106, project management server 107, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of resource management platform 102, first user device 103, second user device 104, enterprise development server 105, enterprise testing server 106, and/or project management server 107 may, in some instances, be special-purpose computing devices configured to perform specific functions.

Referring to FIG. 1B, resource management platform 102 may include one or more processors 111, memory 112, and communication interface 113. A data bus may interconnect processor 111, memory 112, and communication interface 113. Communication interface 113 may be a network interface configured to support communication between resource management platform 102 and one or more networks (e.g., network 101, or the like). Memory 112 may include one or more program modules having instructions that when executed by processor 111 cause resource management platform 102 to perform one or more functions described herein and/or one or more databases that may store and/or otherwise maintain information which may be used by such program modules and/or processor 111. In some instances, the one or more program modules and/or databases may be stored by and/or maintained in different memory units of resource management platform 102 and/or by different computing devices that may form and/or otherwise make up resource management platform 102. For example, memory 112 may have, host, store, and/or include resource management module 112a, resource management database 112b, and a machine learning engine 112c.

Resource management module 112a may have instructions that direct and/or cause resource management platform 102 to execute advanced machine learning techniques related to dynamic resource management, as discussed in greater detail below. Resource management database 112b may store information used by resource management module 112a and/or resource management platform 102 in application of machine learning techniques related to dynamic resource management, and/or in performing other functions. Machine learning engine 112c may have instructions that direct and/or cause the resource management platform 102 to set, define, and/or iteratively refine optimization rules and/or other parameters used by the resource management platform 102 and/or other systems in computing environment 100.

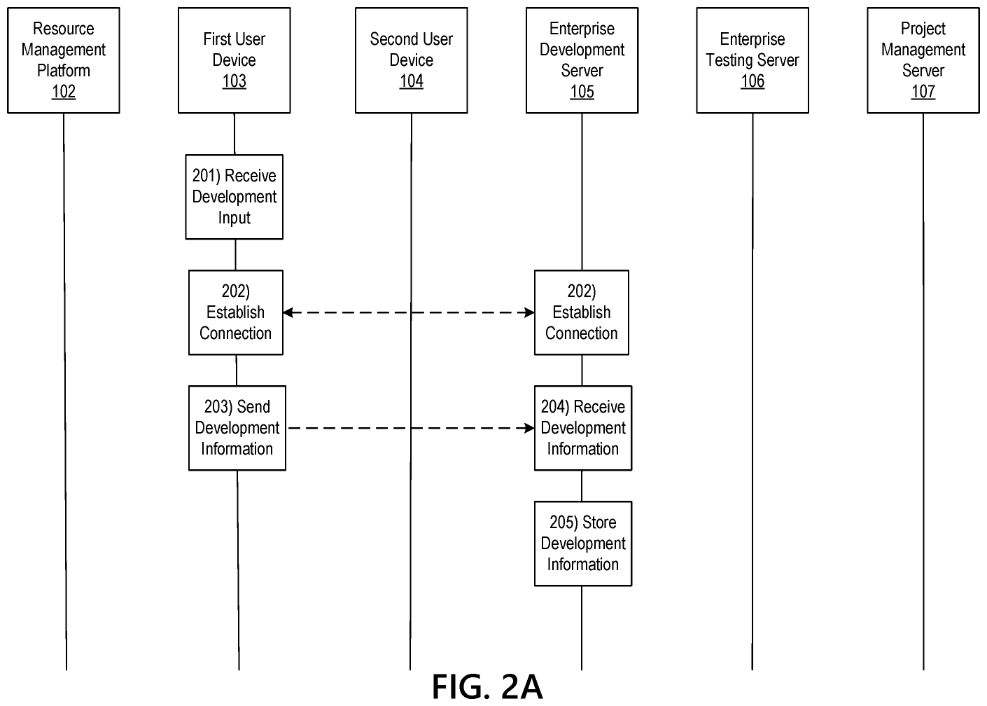

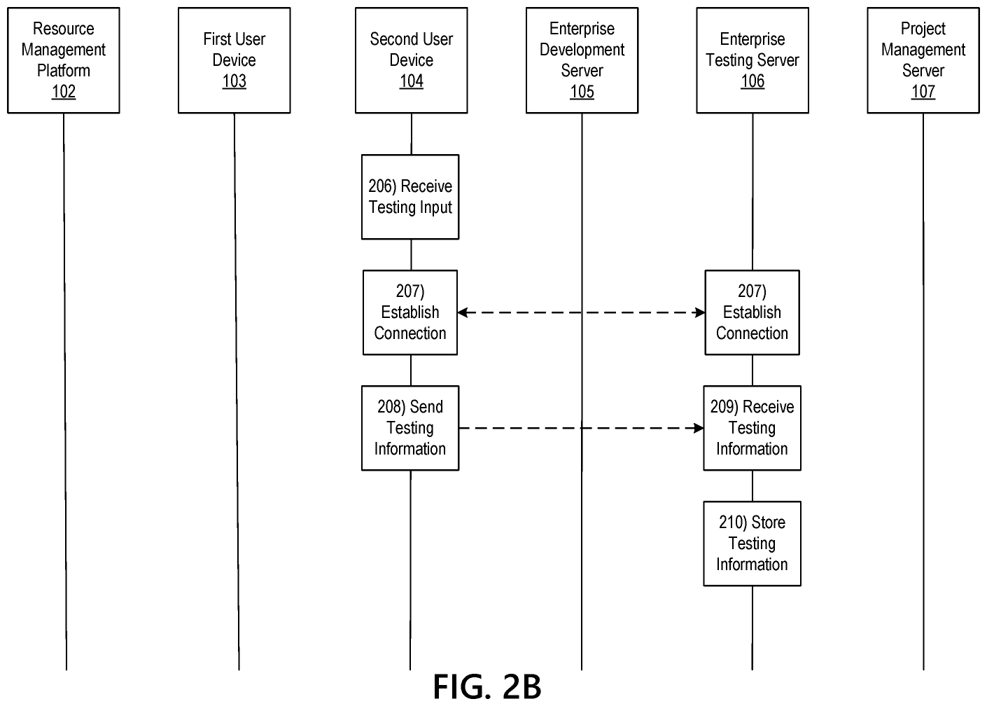

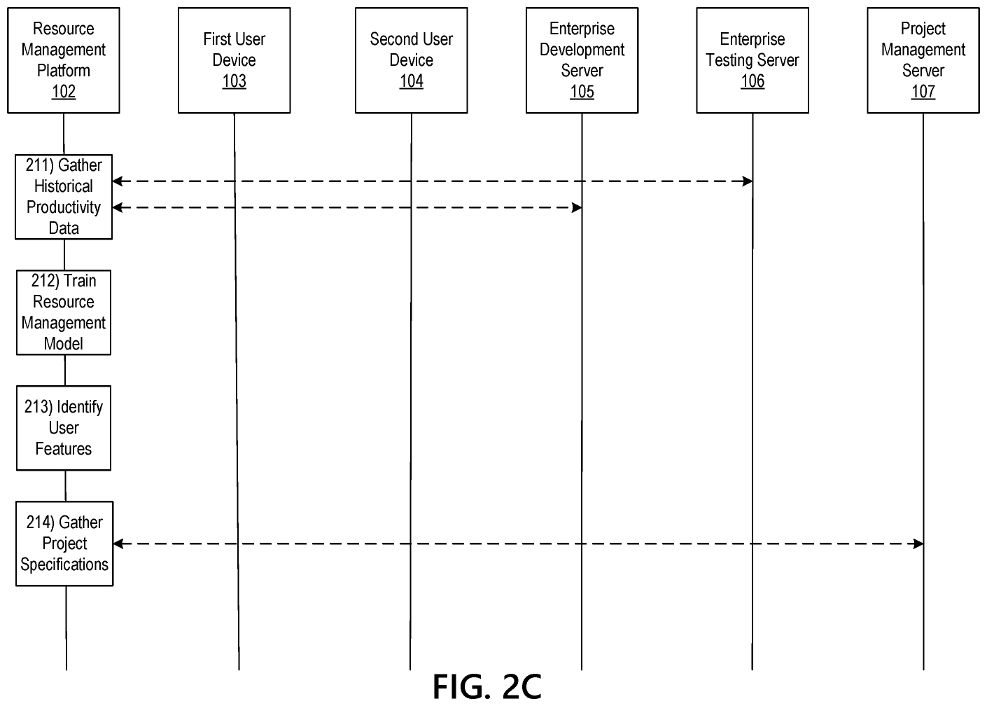

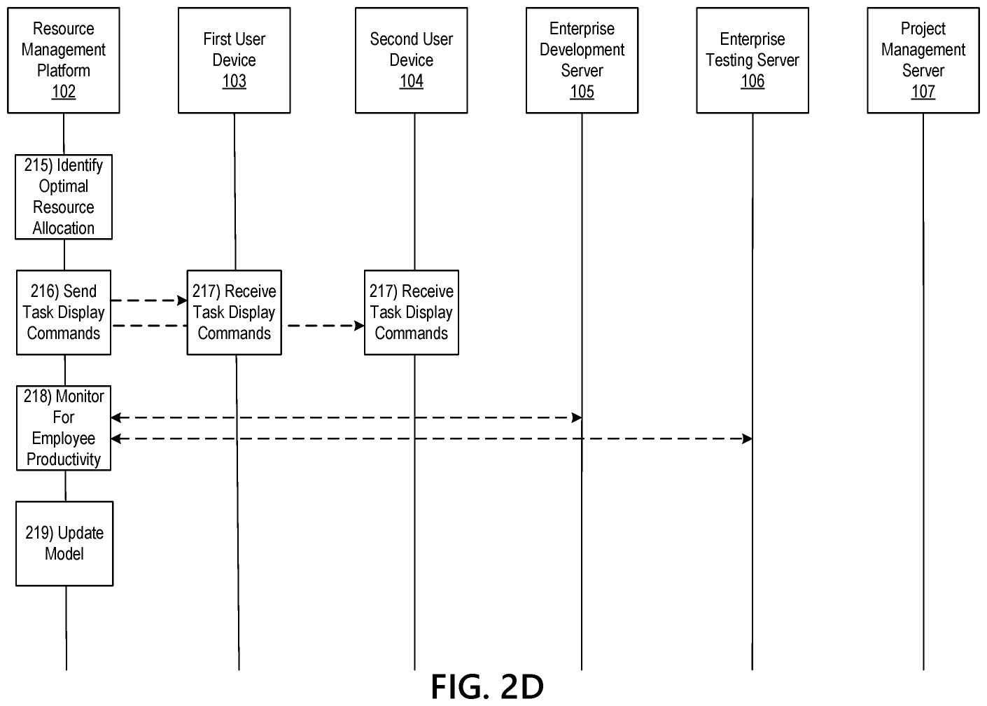

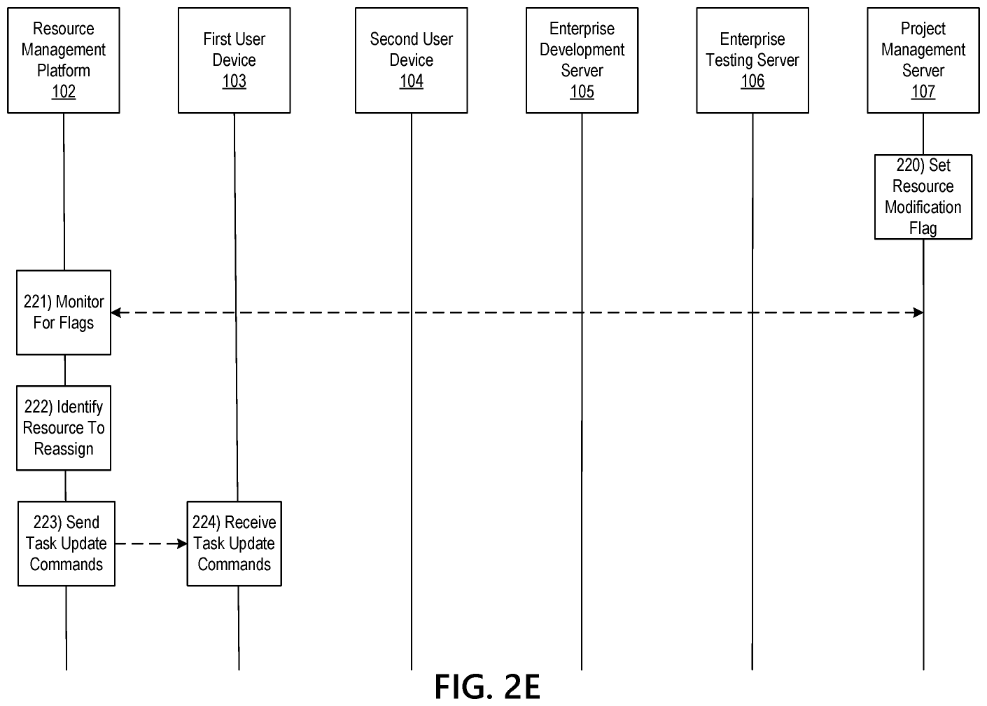

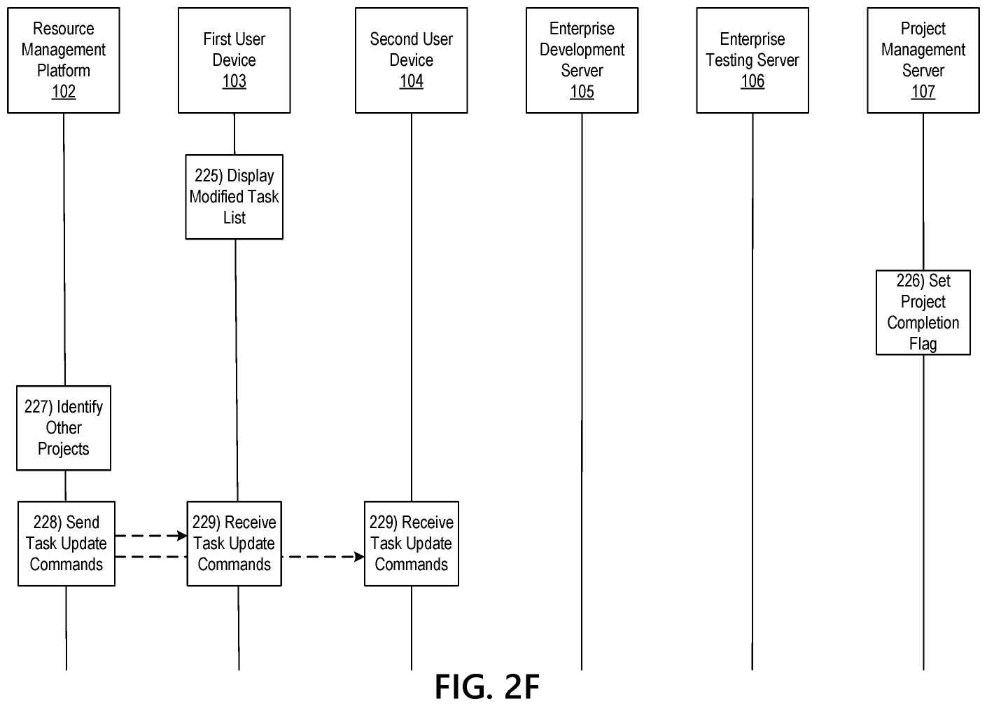

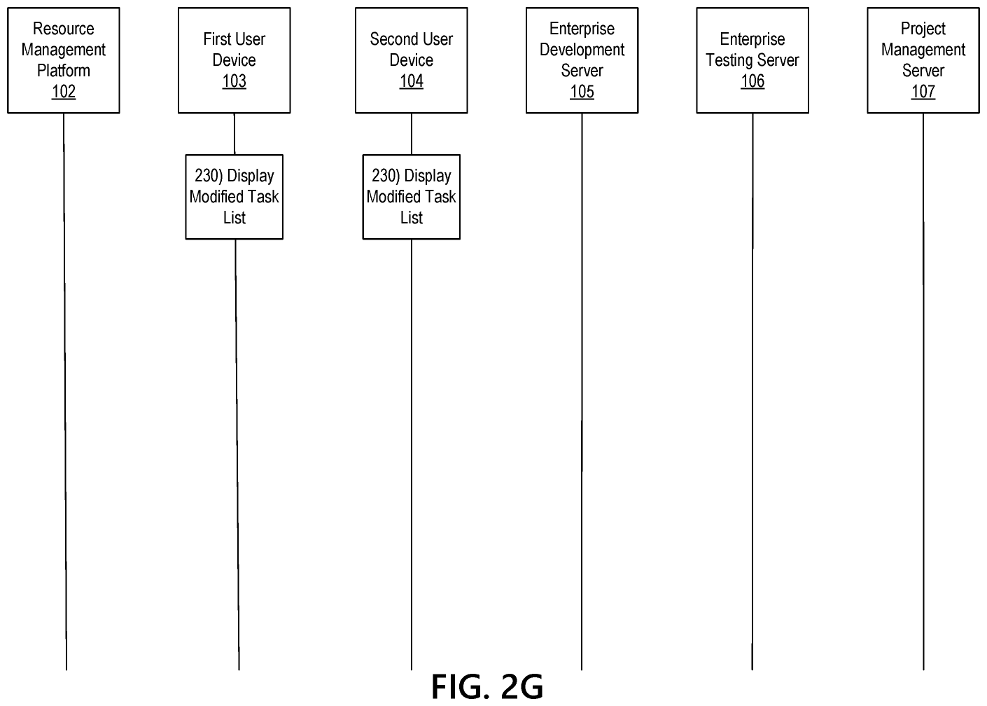

FIGS. 2A-2G depict an illustrative event sequence that implements machine learning techniques for dynamic resource management in accordance with one or more example embodiments. Referring to FIG. 2A, at step 201, first enterprise applications running on at least one user device (e.g., first user device 103) may receive a development input. For example, first enterprise applications running on at least one user device (e.g., first user device 103) may be used by a software developer to perform one or more tasks related to agile development, or the like. In this example, first enterprise applications running on at least one user device (e.g., first user device 103) may receive user inputs related to composing code, fixing bugs within the code, or the like.

At step 202, first enterprise applications running on at least one user device (e.g., first user device 103) may establish a connection with enterprise development server 105. For example, first enterprise applications running on at least one user device (e.g., first user device 103) may establish a first wireless data connection with enterprise development server 105 to link first enterprise applications running on at least one user device (e.g., first user device 103) to the enterprise development server 105 (e.g., in preparation for sending development information to the enterprise development server 105).

At step 203, first enterprise applications running on at least one user device (e.g., first user device 103) may send development information (e.g., representative of the development inputs received at step 201) to the enterprise development server 105. In some instances, the first enterprise applications running on at least one user device (e.g., first user device 103) may send the development information to the enterprise development server 105 while the first wireless data connection is established.

At step 204, the enterprise development server 105 may receive the development information sent at step 203. In these instances, the enterprise development server 105 may receive the development information while the first wireless data connection is established. In some instances, there may be a continuous flow of information from the first enterprise applications running on at least one user device (e.g., first user device 103) to the enterprise development server 105 as one or more development tasks are performed at the first enterprise applications running on at least one user device (e.g., first user device 103).

At step 205, the enterprise development server 105 may store the development information received at step 204. In some instances, the enterprise development server 105 may store the development information along with a user or employee identifier, so that the development information may be used to evaluate performance, productivity, or the like on an employee by employee basis (e.g., developer by developer in this example). For example, the enterprise development server 105 may store a number of lines of code composed/checked into production, a number of bugs fixed, or the like for each employee.

In some instances, the enterprise development server 105 may store the development information along with a project tag and/or other project information. For example, the enterprise development server 105 may store user or employee identifiers of other employees staffed on a project related to the development information, project compositions (e.g., two developers, one tester, and one project manager versus one developer, three testers, and one project manager, or the like) of projects related to the development information, or the like. In some instances, in storing the project compositions, the enterprise development server 105 may store project compositions to an even greater granularity than described above. For example, within each job function (e.g., developer, tester, project manager, or the like) there may be multiple ranks (e.g., one or more levels of seniority such as junior developer, senior developer, managing developer, or the like), and these levels may be included in the project compositions (e.g., one junior developer, one senior developer, one senior tester, and one senior project manager, or the like). In some instances, the enterprise development server 105 may determine these levels of seniority based on the development information. For example, if a number of lines of code composed by an employee does not exceed a first threshold, the enterprise development server 105 may determine that the employee is a junior developer. If the number of lines of code composed by the employee exceeds the first threshold but not a second threshold, the enterprise development server 105 may determine that the employee is a senior developer. If the number of lines of code composed by the employee exceeds the second threshold, the enterprise development server 105 may determine that the employee is a managing developer. Additionally or alternatively, the enterprise development server 105 may store employee skills as part of the project compositions (e.g., one employee with Java proficiency, one employee with C++ proficiency, or the like) which may, in some instances, be similar to endorsements on a professional social networking platform. Additionally or alternatively, the enterprise development server 105 may store project specifications (e.g., timeline, objectives, or the like).

Referring to FIG. 2B, at step 206, second enterprise applications running on at least one user device (e.g., second user device 104) may receive a testing input. For example, second enterprise applications running on at least one user device (e.g., second user device 104) may be used by a software tester to perform one or more tasks related to testing in an agile software environment, or the like. In this example, second enterprise applications running on at least one user device (e.g., second user device 104) may receive user inputs related to running test cases (e.g., on code developed by a programmer such as a user of first enterprise applications running on at least one user device (e.g., first user device 103)), documenting tests, or the like.

At step 207, second enterprise applications running on at least one user device (e.g., second user device 104) may establish a connection with enterprise testing server 106. For example, second enterprise applications running on at least one user device (e.g., second user device 104) may establish a second wireless data connection with enterprise testing server 106 to link second enterprise applications running on at least one user device (e.g., second user device 104) to the enterprise testing server 106 (e.g., in preparation for sending testing information to the enterprise testing server 106).

At step 208, second enterprise applications running on at least one user device (e.g., second user device 104) may send testing information (e.g., representative of the testing inputs received at step 206) to the enterprise testing server 106. In some instances, the second enterprise applications running on at least one user device (e.g., second user device 104) may send the testing information to the enterprise testing server 106 while the second wireless data connection is established.

At step 209, the enterprise testing server 106 may receive the testing information sent at step 208. In these instances, the enterprise testing server 106 may receive the testing information while the second wireless data connection is established. In some instances, there may be a continuous flow of information from the second enterprise applications running on at least one user device (e.g., second user device 104) to the enterprise testing server 106 as one or more testing tasks are performed at the first enterprise applications running on at least one user device (e.g., first user device 103).

At step 210, the enterprise testing server 106 may store the testing information received at step 209. In some instances, the enterprise testing server 106 may store the testing information along with a user or employee identifier, so that the testing information may be used to evaluate performance, productivity, or the like on an employee by employee basis (e.g., tester by tester in this example). For example, the enterprise testing server 106 may store a total number of test cases run and documented over a period of time for each employee.

In some instances, the enterprise testing server 106 may store the testing information along with a project tag and/or other project information. For example, the enterprise testing server 106 may store user or employee identifiers of other employees staffed on a project related to the testing information, project compositions (e.g., two developers, one tester, and one project manager versus one developer, three testers, and one project manager, or the like) of projects related to the testing information, or the like. In some instances, in storing the project compositions, the enterprise testing server 106 may store project compositions to an even greater granularity than described above. For example, within each job function (e.g., developer, tester, project manager, or the like) there may be multiple ranks (e.g., one or more levels of seniority such as junior tester, senior tester, managing tester, or the like), and these levels may be included in the project compositions (e.g., one junior developer, one senior developer, one senior tester, and one senior project manager, or the like). In some instances, the enterprise testing server 106 may determine these levels of seniority based on the testing information. For example, if number of tests run by an employee does not exceed a first threshold, the enterprise testing server 106 may determine that the employee is a junior tester. If the number of tests run by the employee exceeds the first threshold but not a second threshold, the enterprise testing server 106 may determine that the employee is a senior tester. If the number of tests run by the employee exceeds the second threshold, the enterprise testing server 106 may determine that the employee is a managing tester. Additionally or alternatively, the enterprise testing server 106 may store employee skills as part of the project compositions (e.g., one employee with Java proficiency, one employee with C++ proficiency, or the like), which may, in some instances, be similar to endorsements on a professional social networking platform. Additionally or alternatively, the enterprise development server 105 may store project specifications (e.g., timeline, objectives, cost, or the like).

Referring to FIG. 2C, at step 211, resource management platform 102 may gather historical productivity data from enterprise development server 105 and enterprise testing server 106. For example, the resource management platform 102 may gather the number of lines of code written, number of lines of code checked into production, number of bugs fixed, number of documented test cases run, or the like for employees across an enterprise organization (e.g., users of first enterprise applications running on at least one user device (e.g., first user device 103), second enterprise applications running on at least one user device (e.g., second user device 104), or the like) and/or third party contractors, vendors, or the like, which may, in some instances, be tagged with additional contextual information as described above (e.g., employee identifiers, project tags, project composition information, job functions/levels of seniority of identified employees, project specifications, or the like). In some instances, the resource management platform 102 may continuously monitor the enterprise development server 105 and the enterprise testing server 106 to dynamically maintain historical productivity data that is representative of employees (both local employees and across offices in a global capacity), contractors, or the like.

At step 212, the resource management platform 102 may train a resource management model using the historical productivity data collected at step 211. For example, the resource management platform 102 may train a model to identify an optimal resource or combination of resources for staffing on a particular task, project, or the like. In doing so, the resource management platform 102 may identify historical productivity data tagged with similar project specifications, and may identify one or more resources or resource combinations that may result in optimal performance of the project and/or specific tasks within the project. Similarly, in addition to training the resource management model to identify an initial resource allocation for various projects, the resource management platform 102 may train the resource management model to perform on the fly resource re-allocation (e.g., allocate a substitute resource due to an absence or other unanticipated event, or the like) as described below. Similarly, the resource management platform 102 may train the resource management model to re-allocate resources upon determining that a project has been completed (e.g., allocate the resources to alternative projects, or the like). In some instances, in training the resource management model, the resource management platform 102 may normalize the historical productivity data so as to compare productivity of resources across a wide array of job titles, seniority levels, skills, or the like (e.g., compare productivity of a developer to productivity of a tester, or the like).

At step 213, the resource management platform 102 may use the resource management model to identify user features corresponding to resources included in the model. For example, the resource management platform 102 may identify particular skills, skill levels, job titles, seniority levels, optimal team compositions (e.g., 2 testers, 1 developer, or the like per team), optimal resource combinations (e.g., Person #1 and Person #2 testing, Person #3 developing, or the like on a team because they all work well together in those roles) or the like corresponding to each of the resources included in the model. In some instances, the historical productivity data received at step 211 may have already been tagged with this information (e.g., by the enterprise development server 105, enterprise testing server 106, or the like). In other instances, the resource management platform 102 may identify these user features based on the historical productivity data. For example, based on participation in a C++ development project, the resource management platform 102 may identify that an employee has at least some proficiency with C++. Similarly, the resource management platform 102 may aggregate the historical productivity data on an individual resource level (e.g., to identify a number of lines of code written by a particular employee, or the like). Based on this aggregated historical productivity data, the resource management model may identify a level of seniority of the resources (e.g., an individual has written over 10,000 lines of code, so is a senior developer). Additionally or alternatively, the resource management platform 102 may identify optimal project compositions, teammates, or the like for a particular resource based on the historical productivity data (e.g., by comparing productivity of the individual on projects with different compositions, teammates, or the like). Additionally or alternatively, the resource management platform 102 may compute benchmark productivity levels (e.g., benchmark number of lines of code written, number of tests run, number of lines of text written, number of flowcharts drawn, or the like) by averaging performance data of similarly situated resources across the enterprise organization (e.g., same job title, same skills, same level of seniority, same project constraints, or the like). In these instances, the resource management platform 102 may compare performance data for a particular resource to corresponding benchmark productivity levels to identify productivity metrics for the particular resource. For example, the resource management platform 102 may compare performance of a senior developer to benchmark performance data for other senior developers across the enterprise organization.

In doing so, the resource management platform 102 may effectively identify areas in which the resources may be most effective (e.g., based on their skills, job titles, proficiency, or the like) and under what conditions the resources are most effective within these areas (e.g., based on team/project compositions, or the like). After identifying these user features, the resource management platform 102 may store the user features within the resource management model (e.g., as user profiles, or the like) that may be used to identify optimal resource combinations. In some instances, the resource management platform 102 may store all productivity data corresponding to a resource in the corresponding user profile for that resource.

At step 214, the resource management platform 102 may gather project specifications for a particular project from the project management server 107. For example, the resource management platform 102 may gather project timelines, tasks, objectives, budgets, or the like corresponding to a project that has not yet been initiated. In some instances, these project specifications may be input to the project management server 107 by a project manager of an enterprise organization and/or automatically identified based on one or more goals of the project. In some instances, these project specifications may correspond to an agile software development project.

Referring to FIG. 2D, at step 215, the resource management platform 102 may identify an optimal resource allocation for the project using the resource management model. For example, the resource management platform 102 may identify historical productivity data corresponding to the project specifications received at step 214. The resource management platform 102 may then use the resource management model to identify resources corresponding the identified historical productivity data, and compare the identified resources to select an optimal combination of resources for the project (e.g., to be staffed on the project). For illustrative purposes, it is assumed that the resource management platform 102 identified resources corresponding to first enterprise applications running on at least one user device (e.g., first user device 103) and second enterprise applications running on at least one user device (e.g., second user device 104) as comprising an optimal resource combination for the project. In doing so, the resource management platform 102 may identify tasks to be performed by each resource of the optimal resource allocation over the course of the project (e.g., with the user of the first enterprise applications running on at least one user device (e.g., first user device 103) working as a developer and the user of the second enterprise applications running on at least one user device (e.g., second user device 104) working as a tester). For example, the resource management platform 102 may assign development tasks for the project to the user of the first enterprise applications running on at least one user device (e.g., first user device 103) and testing tasks for the project to the user of the second enterprise applications running on at least one user device (e.g., second user device 104) (e.g., because the user of the first enterprise applications running on at least one user device (e.g., first user device 103) may have been identified as a more skilled/productive developer, but less skilled/productive tester than the user of the second enterprise applications running on at least one user device (e.g., second user device 104)).

At step 216, the resource management platform 102 may generate and send one or more commands directing the first enterprise applications running on at least one user device (e.g., first user device 103) and the second enterprise applications running on at least one user device (e.g., second user device 104) to display customized task lists for the project. For example, the resource management platform 102 may send one or more commands directing the first enterprise applications running on at least one user device (e.g., first user device 103) to display tasks related to development and may send one or more commands directing the second enterprise applications running on at least one user device (e.g., second user device 104) to display tasks related to testing for an agile software project. In some instances, the resource management platform 102 may establish wireless data connections with the first enterprise applications running on at least one user device (e.g., first user device 103) (e.g., a third wireless data connection) and the second enterprise applications running on at least one user device (e.g., second user device 104) (e.g., a fourth wireless data connection), and may send the commands to display the various task lists via the communication interface 113 and while the third and fourth wireless data connections are established with the first enterprise applications running on at least one user device (e.g., first user device 103) and the second enterprise applications running on at least one user device (e.g., second user device 104).

At step 217, the first enterprise applications running on at least one user device (e.g., first user device 103) and the second enterprise applications running on at least one user device (e.g., second user device 104) may receive the one or more commands to display the various task lists sent at step 216. In some instances, the first enterprise applications running on at least one user device (e.g., first user device 103) and the second enterprise applications running on at least one user device (e.g., second user device 104) may receive the one or more commands to display the various task lists while the third and fourth wireless data connections are established.

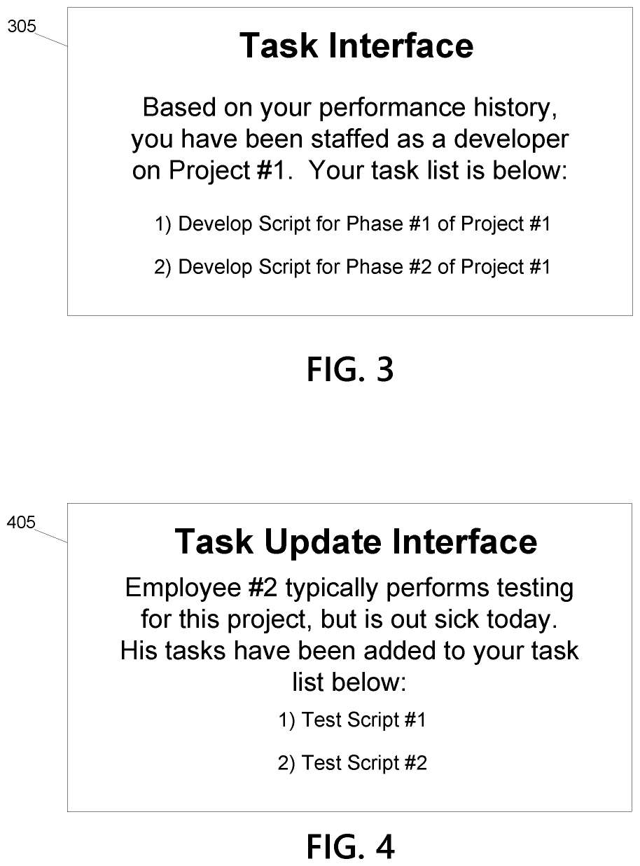

In some instances, based on the one or more commands to display the various task lists, the first enterprise applications running on at least one user device (e.g., first user device 103) and/or the second enterprise applications running on at least one user device (e.g., second user device 104) may display a customized task list (e.g., the commands may cause the first enterprise applications running on at least one user device (e.g., first user device 103) and/or second enterprise applications running on at least one user device (e.g., second user device 104) to display the customized task list). For example, the first enterprise applications running on at least one user device (e.g., first user device 103) may display a graphical user interface similar to graphical user interface 305, which is shown in FIG. 3. For example, the first enterprise applications running on at least one user device (e.g., first user device 103) may display a notification of the project and a role on the project, along with a task list for the user (e.g., who was previously identified as a developer). In this example, the second enterprise applications running on at least one user device (e.g., second user device 104) may display a similar graphical user interface that contains a unique task list for a user of the second enterprise applications running on at least one user device (e.g., second user device 104) (e.g., that includes tasks related to testing).

At step 218, the resource management platform 102 may monitor the enterprise development server 105 and the enterprise testing server 106 for updated productivity data. For example, as users of the first enterprise applications running on at least one user device (e.g., first user device 103) and the second enterprise applications running on at least one user device (e.g., second user device 104) work to complete the tasks displayed at step 217, the first enterprise applications running on at least one user device (e.g., first user device 103) and second enterprise applications running on at least one user device (e.g., second user device 104) may communicate with the enterprise development server 105 and the enterprise testing server 106 respectively. In monitoring for updated productivity data, the resource management platform 102 may collect similar data to the historical productivity data described above at step 211.

At step 219, the resource management platform 102 may update the resource allocation model based on the updated productivity data. In doing so, the resource management platform 102 may continually and dynamically update the resource management model to include both current and historical performance and/or productivity data, which may maintain accuracy of resource allocations identified by the resource management model. For example, the resource management platform 102 may adjust for previously productive performers who have had reduced productivity on the current project, previously unproductive performers who have had increased productivity on the current project, or the like.

Referring to FIG. 2E, at step 220, the project management server 107 may set a resource modification flag indicating a modification to project resources. For example, the project management server 107 may receive information indicating that an employee is sick, on vacation, unable to commute due to inclement weather, or otherwise unable to attend work. In some instances, this information may be input to the project management server 107 by a project manager of the project, or the like. For illustrative purposes, it may be assumed that at step 220 the project management server 107 may set a flag indicating that the user of second enterprise applications running on at least one user device (e.g., second user device 104) is unable to perform his or her assigned tasks.

At step 221, the resource management platform 102 may continuously monitor the project management server 107 (e.g., a project management application that may, in some instances, be hosted by the project management server 107) to detect whether or not any flags have been set. For illustrative purposes, at step 221, the resource management platform 102 may identify the resource modification flag set at step 220.

At step 222, in response to detection of the resource modification flag at step 221, the resource management platform 102 may identify a resource to reassign to the tasks of the user of the second enterprise applications running on at least one user device (e.g., second user device 104). For example, the resource management platform 102 may apply the resource management model to identify a substitute resource (e.g., using methods similar to those described above with regard the identification of an optimal resource allocation at step 215). In some instances, the resource management platform 102 may identify one or more resources not previously assigned to the project (e.g., that may be internal or external resources) or may identify resources currently assigned to the project who may assume the tasks identified by the resource modification flag. In these instances, the resource management platform 102 may make this allocation based on skillsets, productivity data, or the like corresponding to resources already staffed on the project. Additionally or alternatively, the resource management platform 102 may make this decision based on a duration of the resource modification (e.g., employee is out sick for one day so tasks should be handled by another team member versus employee left the company and is no longer available for the project so should be completely replaced). For illustrative purposes, it is assumed that at step 222, the resource management platform 102 may identify that the user of the first enterprise applications running on at least one user device (e.g., first user device 103) is capable of performing these tasks, and they should be assigned to him or her accordingly. For example, the resource management platform 102 may identify that the user of the first enterprise applications running on at least one user device (e.g., first user device 103) is capable of performing these tasks, but might not be as proficient as the user of second enterprise applications running on at least one user device (e.g., second user device 104). Nevertheless, the resource management platform 102 may identify that, to maximize productivity, the user of the first enterprise applications running on at least one user device (e.g., first user device 103) should be assigned to these tasks (e.g., in the alternative, several days may be wasted where the tasks are not accomplished because the responsible employee is out of the office). As another example, the resource management platform 102 may determine that development has been completed for the project, and thus the user of the first enterprise applications running on at least one user device (e.g., first user device 103) who was previously responsible for development should be moved to assist the user of second enterprise applications running on at least one user device (e.g., second user device 104) with testing.

At step 223, the resource management platform 102 may generate and send one or more commands directing the first enterprise applications running on at least one user device (e.g., first user device 103) to display an updated task list that includes the tasks of the user of the second enterprise applications running on at least one user device (e.g., second user device 104). In some instances, the resource management platform 102 may send the one or more commands directing the first enterprise applications running on at least one user device (e.g., first user device 103) to display the updated task list via the communication interface 113 and while the third wireless data connection is established.

At step 224, the first enterprise applications running on at least one user device (e.g., first user device 103) may receive the one or more commands directing the first enterprise applications running on at least one user device (e.g., first user device 103) to display the updated task list from the resource management platform 102. In some instances, the first enterprise applications running on at least one user device (e.g., first user device 103) may receive the one or more commands directing the first enterprise applications running on at least one user device (e.g., first user device 103) to display the updated task list while the third wireless data connection is established.

Referring to FIG. 2F, at step 225, the first enterprise applications running on at least one user device (e.g., first user device 103) may display a modified task list based on the one or more commands directing the first enterprise applications running on at least one user device (e.g., first user device 103) to display the updated task list (e.g., the commands may cause the first enterprise applications running on at least one user device (e.g., first user device 103) to display the modified task list). For example, the first enterprise applications running on at least one user device (e.g., first user device 103) may display a graphical user interface similar to graphical user interface 405, which is shown in FIG. 4. For example, the first enterprise applications running on at least one user device (e.g., first user device 103) my display an updated task list that includes the tasks for the user of the second enterprise applications running on at least one user device (e.g., second user device 104).

At step 226, the project management server 107 may set a project completion flag indicating that the project has been completed. In some instances, the project management server 107 may set the project completion flag based on input from a project manager or may automatically determine that the project has been completed (e.g., based on completion of all related tasks, or the like).

At step 227, the resource management platform 102 may be continuously monitoring the project management server 107 (e.g., the project management application) for flags (e.g., as described at step 221, and may detect the project completion flag. In response to detection of the project completion flag, the resource management platform 102 may determine that the project has been completed, and that resources assigned to the project may be reassigned to other projects. Accordingly, the resource management platform 102 may use the resource management model to identify other pending or planned projects, and may apply similar techniques as those described above at step 215 to identify an optimal allocation of these resources to other projects.

In some instances, the resource management platform 102 may identify these other projects based on communications with the project management server 107, which may track all projects across an enterprise organization in terms of their progress, specifications, resource needs, or the like. Accordingly, the resource management platform 102 may use the resource management model to assign resources to these other projects accordingly.

At step 228, the resource management platform 102 may generate and send one or more commands directing the first enterprise applications running on at least one user device (e.g., first user device 103) and the second enterprise applications running on at least one user device (e.g., second user device 104) to display updated tasks lists based on the projects identified at step 227. In some instances, the resource management platform 102 may send the one or more commands directing the first enterprise applications running on at least one user device (e.g., first user device 103) and the second enterprise applications running on at least one user device (e.g., second user device 104) to display the updated task lists via the communication interface 113 and while the third and fourth wireless data connections are established.

At step 229, the first enterprise applications running on at least one user device (e.g., first user device 103) and the second enterprise applications running on at least one user device (e.g., second user device 104) may receive the one or more commands to display the updated task lists. In some instances, the first enterprise applications running on at least one user device (e.g., first user device 103) and the second enterprise applications running on at least one user device (e.g., second user device 104) may receive the one or more commands to display the updated task lists while the third and fourth wireless data connection are established.

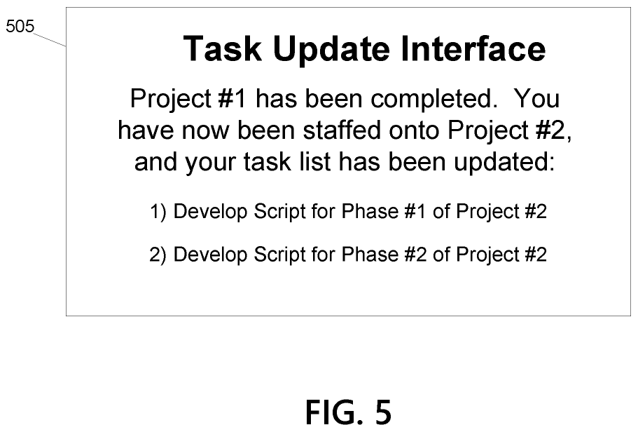

Referring to FIG. 2G, at step 230, based on the one or more commands to display the updated task lists received at step 229, the first enterprise applications running on at least one user device (e.g., first user device 103) and the second enterprise applications running on at least one user device (e.g., second user device 104) may display the updated task lists (e.g., the one or more commands may cause the first enterprise applications running on at least one user device (e.g., first user device 103) and/or the second enterprise applications running on at least one user device (e.g., second user device 104) to display the updated task lists). For example, the first enterprise applications running on at least one user device (e.g., first user device 103) may display a graphical user interface similar to graphical user interface 505, which is shown in FIG. 5. For example, the first enterprise applications running on at least one user device (e.g., first user device 103) may display an indication that a first project has been completed, a second project has been assigned, and a list of tasks corresponding to the second project. In some instances, along with the updated task lists, the first enterprise applications running on at least one user device (e.g., first user device 103) and/or the second enterprise applications running on at least one user device (e.g., second user device 104) may display a request for feedback regarding other resources during the project (e.g., did the employees enjoy working with each other, or the like), and may use received feedback to update the resource management model. In some instances, in receiving the feedback, the first enterprise applications running on at least one user device (e.g., first user device 103) may receive feedback similar to endorsements on a professional social media network, and the feedback may endorse certain resources for certain skills.

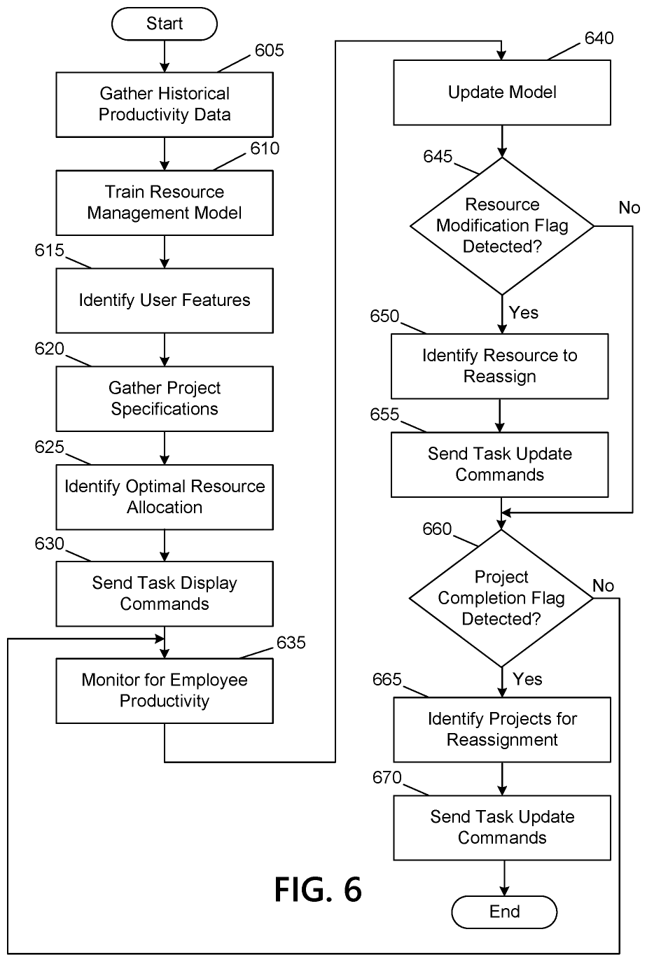

FIG. 6 depicts an illustrative method for implementing machine learning techniques for dynamic resource management in accordance with one or more example embodiments. Referring to FIG. 6, at step 605, a computing platform having at least one processor, a communication interface, and memory may gather historical productivity data. At step 610, the computing platform may train a resource management model using the historical productivity data. At step 615, the computing platform may identify user features using the resource management model. At step 620, the computing platform may gather project specifications from a project management server. At step 625, the computing platform may apply the resource management model to identify an optimal resource allocation based on the project specifications. At step 630, the computing platform may send one or more task display commands directing resources to perform tasks as identified by the optimal resource allocation. At step 635, the computing platform may continue to monitor for employee productivity. At step 640, the computing platform may update the resource management model based on updated employee productivity data. At step 645, the computing platform may determine if a resource modification flag is detected at the project management server. If a resource modification flag is not detected, the computing platform may proceed to step 660. If a resource modification flag is detected, the computing platform may proceed to step 650.

At step 650, the computing platform may apply the resource management model to identify resources to reassign based on the resource modification flag. At step 655, the computing platform may send one or more task update commands directing resources to perform updated tasks corresponding to the reassignments identified at step 650. At step 660, the computing platform may determine whether a project completion flag is detected at the project management server. If a project completion flag is not detected, the computing platform may return to step 635. If a project completion flag is detected, the computing platform may proceed to step 665.

At step 665, the computing platform may apply the resource management model to identify other projects to which resources may be reassigned. At step 670, the computing platform may send one or more task update commands directing resources to perform updated tasks corresponding to the new projects identified.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
collect historical productivity data;
train a resource management model using the historical productivity data;
identify project specifications for a first project;
identify, using the resource management model, a resource allocation combination for the first project;
send one or more task assignment commands to one or more enterprise applications running on one or more user devices corresponding to the resource allocation combination, the one or more task assignment commands directing each of the one or more enterprise applications running on the one or more user devices to display a task list based on the project specifications and the resource allocation combination, wherein sending the one or more task assignment commands to the one or more enterprise applications running on the one or more user devices causes each of the one or more enterprise applications running on the one or more user devices to display the task list;
after sending the one or more task assignment commands to the one or more enterprise applications running on the one or more user devices corresponding to the resource allocation combination, dynamically monitor a project management application;
detect a resource modification flag based on dynamically monitoring the project management application;
in response to detecting the resource modification flag, apply the resource management model to dynamically identify resource reassignments for the first project; and
send one or more task reassignment commands to the one or more enterprise applications running on the one or more user devices corresponding to the resource allocation combination, the one or more task reassignment commands directing each of the one or more enterprise applications running on the one or more user devices to display an updated task list based on the identified resource reassignments, wherein sending the one or more task reassignment commands to the one or more enterprise applications running on the one or more user devices causes each of the one or more enterprise applications running on the one or more user devices to display the updated task list.

2. The computing platform of claim 1, wherein the memory stores additional computer-readable instructions that, when executed by the at least one processor, further cause the computing platform to:
detect a project completion flag based on dynamically monitoring the project management application;
in response to detecting the project completion flag, apply the resource management model to dynamically identify alternate projects to which resources comprising the resource allocation combination may be reassigned; and
send one or more project reassignment commands to the one or more enterprise applications running the one or more user devices corresponding to the resource allocation combination, the one or more project reassignment commands directing each of the one or more enterprise applications running on the one or more one user devices to display a second updated task list based on the identified alternate projects, wherein sending the one or more project reassignment commands to the one or more enterprise applications running on the one or more user devices causes each of the one or more enterprise applications running on the one or more user devices to display the second updated task list.

3. The computing platform of claim 1, wherein:
the historical productivity data comprises productivity data for individual resources based on: their performance with regard to other specific resources, their performance on teams with specific compositions, or their performance within a job function; and
the historical productivity data is stored using resource profiles.

4. The computing platform of claim 3, wherein each resource profile includes the job function and a rank within the job function.

5. The computing platform of claim 4, wherein the memory stores additional computer-readable instructions that, when executed by the at least one processor, further cause the computing platform to:
compute, for each of the resource profiles, the productivity data based on the performance within a job function by comparing actual performance metrics stored in the resource profiles to benchmark performance metrics corresponding to the job function and the rank within the job function.

6. The computing platform of claim 5, wherein the benchmark performance metrics are specific to the job function and the rank within the job function.

7. The computing platform of claim 6, wherein the benchmark performance metrics comprise one or more of: a number of lines of code written, a number of tests run, a number of lines of text written, or a number of flowcharts drawn.

8. The computing platform of claim 1, wherein the historical productivity data corresponds to internal resources and external resources.

9. The computing platform of claim 2, wherein the memory stores additional computer-readable instructions that, when executed by the at least one processor, further cause the computing platform to:
in response to detecting the project completion flag, send one or more feedback commands to the one or more enterprise applications running on the one or more user devices corresponding to the resource allocation combination;
receive, from the one or more enterprise applications running on the one or more user devices corresponding to the resource allocation combination, feedback corresponding to the resource allocation combination; and
update, using the feedback, the resource management model.

10. The computing platform of claim 3, wherein the specific compositions comprise specific numbers of resources on the teams corresponding to a particular job function and a particular rank within the job function.

11. A method comprising:
at a computing platform comprising at least one processor, a communication interface, and memory:
collect historical productivity data;
training a resource management model using the historical productivity data;
identifying project specifications for a first project;
identifying, using the resource management model, a resource allocation combination for the first project;
sending one or more task assignment commands to one or more enterprise applications running on one or more user devices corresponding to the resource allocation combination, the one or more task assignment commands directing each of the one or more enterprise applications running on the one or more user devices to display a task list based on the project specifications and the resource allocation combination, wherein sending the one or more task assignment commands to the one or more enterprise applications running on the one or more user devices causes each of the one or more enterprise applications running on the one or more user devices to display the task list;
after sending the one or more task assignment commands to the one or more enterprise applications running on the one or more user devices corresponding to the resource allocation combination, dynamically monitoring a project management application;
detecting a resource modification flag based on dynamically monitoring the project management application;
in response to detecting the resource modification flag, applying the resource management model to dynamically identify resource reassignments for the first project; and
sending one or more task reassignment commands to the one or more enterprise applications running on the one or more user devices corresponding to the resource allocation combination, the one or more task reassignment commands directing each of the one or more enterprise applications running on the one or more user devices to display an updated task list based on the identified resource reassignments, wherein sending the one or more task reassignment commands to the one or more enterprise applications running on the one or more user devices causes each of the one or more enterprise applications running on the one or more user devices to display the updated task list.

12. The method of claim 11, further comprising:
detecting a project completion flag based on dynamically monitoring the project management application;
in response to detecting the project completion flag, applying the resource management model to dynamically identify alternate projects to which resources comprising the resource allocation combination may be reassigned; and
sending one or more project reassignment commands to the one or more enterprise applications running on the one or more user devices corresponding to the resource allocation combination, the one or more project reassignment commands directing each of the one or more enterprise applications running on the one or more user devices to display a second updated task list based on the identified alternate projects, wherein sending the one or more project reassignment commands to the one or more enterprise applications running on the one or more user devices causes each of the one or more enterprise applications running on the one or more user devices to display the second updated task list.

13. The method of claim 11, wherein:
the historical productivity data comprises productivity data for individual resources based on: their performance with regard to other specific resources, their performance on teams with specific compositions, or their performance within a job function; and
the historical productivity data is stored using resource profiles.

14. The method of claim 13, wherein each resource profile includes the job function and a rank within the job function.

15. The method of claim 14, further comprising:
computing, for each of the resource profiles, the productivity data based on the performance within a job function by comparing actual performance metrics stored in the resource profiles to benchmark performance metrics corresponding to the job function and the rank within the job function.

16. The method of claim 15, wherein the benchmark performance metrics are specific to the job function and the rank within the job function.

17. The method of claim 16, wherein the benchmark performance metrics comprise one or more of: a number of lines of code written, a number of tests run, a number of lines of text written, or a number of flowcharts drawn.

18. The method of claim 11, wherein the historical productivity data corresponds to internal resources and external resources.

19. The method of claim 12, further comprising:
in response to detecting the project completion flag, sending one or more feedback commands to the one or more enterprise applications running on the one or more user devices corresponding to the resource allocation combination;
receiving, from the one or more enterprise applications running on the one or more user devices corresponding to the resource allocation combination, feedback corresponding to the resource allocation combination; and
updating, using the feedback, the resource management model.

20. One or more non-transitory computer-readable media storing instructions that, when executed by a computing platform comprising at least one processor, a communication interface, and memory, cause the computing platform to:
collect historical productivity data;
train a resource management model using the historical productivity data;
identify project specifications for a first project;
identify, using the resource management model, a resource allocation combination for the first project;
send one or more task assignment commands to one or more enterprise applications running on one or more user devices corresponding to the resource allocation combination, the one or more task assignment commands directing each of the one or more enterprise applications running on the one or more user devices to display a task list based on the project specifications and the resource allocation combination, wherein sending the one or more task assignment commands to the one or more enterprise applications running on the one or more user devices causes each of the one or more enterprise applications running on the one or more user devices to display the task list;
after sending the one or more task assignment commands to the one or more enterprise applications running on the one or more user devices corresponding to the resource allocation combination, dynamically monitor a project management application;
detect a resource modification flag based on dynamically monitoring the project management application;
in response to detecting the resource modification flag, apply the resource management model to dynamically identify resource reassignments for the first project; and
send one or more task reassignment commands to the one or more enterprise applications running on the one or more user devices corresponding to the resource allocation combination, the one or more task reassignment commands directing each of the one or more enterprise applications running on the one or more user devices to display an updated task list based on the identified resource reassignments, wherein sending the one or more task reassignment commands to the one or more enterprise applications running on the one or more user devices causes each of the one or more enterprise applications running on the one or more user devices to display the updated task list.
